(19) United States
(12) Patent Application Publication
(10) Pub. No.: US 2024/0052839 A1
(43) Pub. Date: Feb. 15, 2024

(54) SCROLL COMPRESSOR

(71) Applicant: LG ELECTRONICS INC., Seoul (KR)

(72) Inventors: Seungmock LEE, Seoul (KR); Cheolhwan KIM, Seoul (KR)

(21) Appl. No.: 18/271,498

(22) PCT Filed: Oct. 6, 2021
(86) PCT No.: PCT/KR2021/013720

§ 371 Date: Jul. 10, 2023

(30) Foreign Application Priority Data
Jan. 22, 2021 (KR) 10-2021-0009483

(51) Int. Cl. F04C 29/12; F04C 18/02; F04C 29/06

(52) U.S. Cl. CPC F04C 29/12; F04C 18/0215; F04C 29/06

(57) ABSTRACT

A scroll compressor is disclosed. A scroll compressor according to an embodiment of the present invention comprises: a compression part for discharging, to the inner space of a casing, a refrigerant compressed in a compression chamber; a discharge port for forming a flow path through which the refrigerant compressed in the compression chamber is discharged to the outside of the compression chamber; and a valve member, which has, at one end portion thereof, a root part fixed to a valve seat part of the compression part, forms a free end on the other end portion thereof, and has a head part to open/close the discharge port. A spacing part is provided between the head part of the valve member and the valve seat part to space the head part from the valve seat part in a state in which the compression part stops. Therefore, during operation of the valve member, the moving speed of the head part is reduced by means of the stiffness of the valve member so that impact force generated when the head part of the valve member collides with one surface of the compression part is reduced and impact noise generated thereby can be decreased.

### TECHNICAL FIELD

The present disclosure relates to a scroll compressor having a valve member for opening and closing a discharge port through which compressed refrigerant is discharged.

### BACKGROUND ART

In general, a hermetic compressor includes, in an inner space of a casing thereof, a drive motor generating driving force and a compression unit that is coupled to the drive motor to compress suctioned refrigerant during operation. Such hermetic compressors may be classified into a reciprocating type, a scroll type, a rotary type, a vibration type, and the like according to a method of compressing refrigerant. The reciprocating type, the scroll type, and the rotary type use rotational force of a drive motor while the vibration type uses a reciprocating motion of a drive motor.

In addition, in the case of a scroll type or rotary type compressor among hermetic compressors, a discharge port of a compression unit through which compressed refrigerant is discharged communicates with an inner space of a casing, and a valve member is installed in the discharge port to open and close the discharge port to control a flow of the refrigerant discharged into the inner space of the casing from a compression chamber of the compression unit.

Meanwhile, a reed type valve member is applied as the valve member. In general, the reed type valve member is configured such that one end portion thereof formed in a thin plate shape is fixed to the compression unit and another end portion is formed as a free end to open and close the discharge port according to a pressure difference between the compression chamber of the compression unit and the inner space of the casing. In addition, the compressor may include a retainer for limiting a degree of bending of the another end portion forming the free end of the reed type valve member during an opening and closing operation of the reed type valve member.

In the case of the related art reed type valve member, when the valve member opens and closes the discharge port, a pressure reversal phenomenon occurs between the compression chamber of the compression unit and the inner space of the casing. Especially, the pressure reversal occurs more frequently in the scroll compressor than other hermetic compressors with different compression methods.

In addition, in the related art reed type valve member, the another end portion forming the free end hermetically blocks the discharge port of the compression unit before the compressor operates, that is, before the pressure reversal phenomenon occurs between the compression chamber and the inner space of the casing.

According to the structural characteristics of the reed type valve member, when the reed type valve member opens and closes the discharge port, the another end portion forming the free end of the reed type valve member repeatedly collides with an upper surface of the compression unit where the discharge port is disposed and a lower surface of the retainer, thereby continuously generating metallic impact noise.

Patent Document 1 (Korean Patent Publication No. 10-2012-0045958) and Patent Document 2 (Korean Patent Publication No. 10-2005-0028218) each disclose a valve structure applied to a scroll compressor.

In the case of Patent Document 1, an elastic member for elastically supporting a ball-shaped valve member that opens and closes a discharge port is disposed to reduce impact noise generated during operation of the valve member. In addition, in the case of Patent Document 2, an elastic member having a structure similar to that of a valve member is disposed between the valve member and an upper surface of the compression unit to reduce impact noise generated during operation of the valve member.

However, in Patent Document 1 and Patent Document 2, an additional component such as the elastic member is required compared to the related art, and deformation continuously and frequently occurs in the additionally provided elastic member as the valve member operates. This may lower reliability of the operation of the valve member.

### DISCLOSURE OF INVENTION

### Technical Problem

One aspect of the present disclosure is to provide a scroll compressor capable of reducing impact noise generated due to collision between a valve member and a valve seat surface of a compression unit while the valve member opens and closes a discharge port.

Another aspect of the present disclosure is to provide a scroll compressor capable of reducing valve impact noise by configuring a valve member to collide with a valve seat surface after passing a valve parallel line when the valve member is closed.

Still another aspect of the present disclosure is to provide a scroll compressor capable of reducing stress concentration occurring at a fixed end portion of a valve member when the valve member is closed.

### Solution to Problem

To achieve these and other advantages and in accordance with the purpose of the present invention, as embodied and broadly described herein, there is provided a scroll compressor that may include: a compression unit having a discharge port defining a flow path through which refrigerant compressed in a compression chamber is discharged to outside of the compression chamber; and a valve member having a root part fixed to a valve seat part of the compression unit and a head part for opening and closing the discharge port. The head part of the valve member may be spaced apart from the discharge port. Through this, when the valve member is closed, the head part may collide with a valve seat surface over a valve parallel line, thereby reducing impact noise generated by collision between the head part of the valve member and the valve seat part.

Specifically, the scroll compressor includes a compression unit disposed in an inner space of the casing, having a compression chamber defining a compression space for compressing suctioned refrigerant therein, and discharging the refrigerant compressed in the compression chamber into the inner space of the casing; a discharge port defining a flow path through which the refrigerant compressed in the compression chamber is discharged to outside of the compression chamber, and a valve member having a root part disposed on one end portion thereof to be fixed to a valve seat part of the compression unit, and a head part disposed on another end portion to define a free end so as to open and close the discharge port. Here, a spacing part may be disposed between the head part of the valve member and the valve seat part facing the head part such that the head part is spaced apart from the valve seat part in a stopped state of the compression unit. Through this, when the valve member is closed, the head part may collide with a valve seat surface over a valve parallel line, thereby increasing a distance until the head part of the valve member collides with one surface of the compression unit provided with the discharge port. Accordingly, a moving speed of the head part may be reduced by rigidity of the valve member, which can decrease impact force by which the head part of the valve member collides with the one surface of the compression unit and reduce valve collision sound generated upon the collision.

The valve seat part may include a valve fixing surface to which the root part of the valve member is fixed, and a valve opening and closing surface to open and close the head part of the valve member, and the valve fixing surface is located at a position higher than the valve opening and closing surface. Through this, a lower surface of the head part of the valve member can be spaced apart from the valve opening and closing surface by an increased height of a lower surface of the root part of the valve member from the valve opening and closing surface. This can increase a distance until the head part of the valve member collides with the valve opening and closing surface provided with the discharge port, and the rigidity of the valve member can reduce a moving speed of the head part, thereby reducing impact noise generated when the head part collides with the valve opening and closing surface.

The scroll compressor may include a spacer disposed between the root part of the valve member and the valve seat part facing the root part such that a valve fixing surface protrudes from the valve seat part by a predetermined height. Through this, the head part of the valve member may be spaced apart from the discharge port by a thickness of the spacer.

In addition, the spacer may be inserted between the valve member and the valve seat part. Accordingly, a structure of the spacing part can be easily implemented through a process of assembling or bonding the valve member and the spacer.

The spacer may be disposed on the root part of the valve member or the valve seat part facing the root part, and protrude from the valve member toward the valve seat part or protrude from the valve seat part to the root part by a predetermined height. This can exclude a separate component that is supposed to be assembled to implement the spacing part, thereby simplifying the components of the scroll compressor involved in the valve member.

The spacer may be formed in an annular shape and have the same outer diameter along an axial direction. Accordingly, the structure of the spacer can be more simplified and impact noise due to the valve member can be reduced through the structure of the spacing part.

The spacer may include a chamfered portion formed to be inclined downward in a direction toward the discharge port. Accordingly, when the valve member opens and closes the discharge port, an area in contact with one surface of the spacer on a lower surface of the valve member can gradually increase, thereby minimizing stress concentration occurring on a portion adjacent to the root part of the valve member.

The valve seat part may include a valve opening and closing surface that encloses a periphery of the discharge port and is detachable from the head part of the valve member, and the valve opening and closing surface may include a recess portion recessed by a predetermined depth so that the head part and the discharge port are spaced apart from each other. Through this, the head part of the valve member can be spaced apart from one surface of the valve seat part and thus there is no need for a separate configuration for reducing impact noise generated during operation of the valve member. This can more simplify the components for opening and closing the discharge port. By virtue of an exclusion of a separate component that is supposed to be assembled, reliability of the operation of the valve member 140 can be secured even when the valve member is frequently open and closed.

A distance from the root part to an end of the recess portion may be longer than a distance from the root part to an end of the head part. Accordingly, when the valve member opens and closes the discharge port, the head part can be fully received in the recess portion. That is, when the valve member opens and closes the discharge port, a possibility that the head part may collide with any portion of the valve seat part on a movement path of the valve member can be minimized, thereby more reducing the impact noise generated during the operation of the valve member to open and close the discharge port.

The recess portion corresponding to the head part of the valve member may include a valve seat surface formed to be larger than an outer diameter of the head part along the periphery of the discharge port to receive the head part. That is, one end portion of the recess portion corresponding to the head part may be formed up to a position far from a center of the discharge port by a distance longer a radius of the discharge port. This can stably secure an area by which the head part of the valve member is seated on the periphery of the discharge port when the valve member opens and closes the discharge port, thereby more improving reliability of a function of the valve member for opening and closing the discharge port.

The recess portion may be formed such that a recessed depth increases in a direction toward the discharge port. That is, the recess portion may be formed such that the recessed depth decreases from one end portion thereof corresponding to the head part to another end portion. Accordingly, when the valve member opens and closes the discharge port, an area in which the lower surface of the valve member comes in contact with one surface of the recess portion can gradually increase, so as to minimize a phenomenon of stress concentration that occurs on a portion adjacent to the root part of the valve member during the opening and closing operation of the valve member.

The recess portion may be formed in a long groove shape along a longitudinal direction of the valve member, the discharge port may be formed eccentrically on a side far from the root part, and an inclined portion may be formed to be inclined downward on a portion, adjacent to the root part, of an inner circumferential surface of the recess portion. Accordingly, when the valve member opens and closes the discharge port, an area where a portion, adjacent to the root part, of the lower surface of the valve member comes into contact with one surface of the recess portion may gradually increase. This can minimize stress concentration that occurs on a portion adjacent to the root part during the opening and closing operation of the valve member.

The valve member may be formed in a flat plate shape, when viewed from a side, by extending the root part and the head part linearly along the valve seat part. This can minimize impact noise generated during the operation of the valve member and facilitate the valve member in the flat plate shape with excellent machining and assembly properties to be applied to the scroll compressor.

The valve member may include an elastic part disposed between the root part and the head part, and the elastic part may include a bent portion bent such that the head part is directed away from the valve seat part. This can exclude a separate component required for the head part of the valve member to be spaced apart from the one surface of the valve seat part, and allow the head part to be spaced apart from the valve seat part by using structural characteristics of the bent portion, thereby more simplifying the components for opening and closing the discharge port disposed in the compression unit.

The scroll compressor may further include a protrusion protruding from the valve seat part toward the valve member. The protrusion may be located at a position closer to the root part than to the head part. This can exclude a separate component required for the head part of the valve member to be spaced apart from the one surface of the valve seat part so as to reduce impact noise generated during the operation of the valve member. Accordingly, a portion for assembling or fixing a separate component involved in the operation of the valve member can be excluded, thereby further securing reliability of the operation of the valve member even when the valve member is frequently open and closed.

In addition, a height of the spacing part disposed between the head part of the valve member and the valve seat part facing the head part may be larger than or equal to a thickness of the valve member. Thus, the spacing part can allow the head part of the valve member and the valve seat part to secure a distance therebetween more stably, thereby providing a more stable effect of reducing impact noise generated during the operation of the valve member.

### Advantageous Effects of Invention

The effects of the present disclosure obtained by the aforementioned solutions are as follows.

A scroll compressor according to the present disclosure includes a valve member having a root part and a head part on one end portion and another end portion thereof, respectively, and a spacing part disposed between the head part of the valve member and the valve seat part facing the head part such that the head part is spaced apart from the valve seat part in a stopped state of a compression unit. Through this, when the valve member is closed, the head part may collide with a valve seat surface over a valve parallel line, thereby increasing a distance until the head part of the valve member collides with one surface of the compression unit provided with a discharge port. Accordingly, a moving speed of the head part can be reduced by rigidity of the valve member, which can decrease impact force by which the head part of the valve member collides with the one surface of the compression unit and reduce impact noise generated upon the collision.

The valve seat part may include a valve opening and closing surface that encloses a periphery of the discharge port and is detachable from the head part of the valve member and the valve opening and closing surface may be provided with a recess portion recessed by a predetermined depth so that the head part of the valve member and the discharge port are spaced apart from each other. On the other hand, the scroll compressor may further include a protrusion protruding from the valve seat part toward the valve member. Through this, there is no need for a separate configuration by which the head part of the valve member is spaced apart from one surface of the valve seat part. This can further simplify the components for opening and closing the discharge port. By virtue of an exclusion of a separate component that is supposed to be assembled, reliability of the operation of the valve member 140 can be further secured even when the valve member is frequently open and closed.

The valve member according to the present disclosure may be provided with an elastic part interposed between the root part and the head part of the valve member, and the elastic part may be provided with a bent portion bent such that the head part is directed away from the valve seat part. This can exclude a separate component required for the head part of the valve member to be spaced apart from the one surface of the valve seat part, and allow the head part of the valve member to be spaced apart from the valve seat part by using structural characteristics of the bent portion, thereby more simplifying the components for opening and closing the discharge port disposed in the compression unit.

The recess portion according to the present disclosure may be formed such that a recessed depth increases in a direction toward the discharge port. Accordingly, an area where the lower surface of the valve member and one surface of the recess portion come in contact with each other gradually increases when the valve member opens and closes the discharge port disposed in the compression unit. this can minimize stress concentration caused by absence of an area where a portion adjacent to the root part of the valve member continuously comes in contact with the lower surface of the valve member during the opening and closing operation of the valve member.

### BRIEF DESCRIPTION OF DRAWINGS

FIG. 1 is a cross-sectional view of a scroll compressor in accordance with one embodiment of the present disclosure.

FIG. 2 is a perspective view of a compression unit illustrated in FIG. 1.

FIG. 3 is an exploded perspective view illustrating components related to a partial valve member in the compression unit illustrated in FIG. 2.

FIG. 4 is a view illustrating a cross-section of the compression unit illustrated in FIG. 2 based on the valve member.

FIG. 5 is a conceptual view illustrating a process of operating the valve member illustrated in FIG. 4.

FIGS. 6 to 8 are cross-sectional views illustrating different examples of the scroll compressor illustrated in FIG. 1 based on the valve member.

FIG. 9 is a perspective view illustrating a compression unit according to still another example of the scroll compressor illustrated in FIG. 1.

FIG. 10 is a schematic view illustrating a cross-section of the compression unit illustrated in FIG. 9.

FIGS. 11 to 12 are cross-sectional views illustrating different examples of the scroll compressor illustrated in FIG. 1 based on the valve member.

FIG. 13 is a perspective view illustrating a compression unit according to still another example of the scroll compressor illustrated in FIG. 1.

FIG. 14 is a schematic view illustrating a cross-section of the compression unit illustrated in FIG. 13.

### MODE FOR THE INVENTION

Hereinafter, description will be given in more detail of a scroll compressor 100 according to the present disclosure, with reference to the accompanying drawings.

For the sake of brief description with reference to the drawings, the same or equivalent components may be provided with the same or similar reference numbers, and description thereof will not be repeated.

A singular representation may include a plural representation unless it represents a definitely different meaning from the context.

In addition, the following description of the scroll compressor 100 according to the present disclosure will be given by taking a hermetic scroll compressor among several types of scroll compressors as an example. However, the scroll compressor 100 according to the present disclosure is not limited to such a hermetic scroll compressor, and may also correspond to other types of scroll compressors in which a reed type valve member is used.

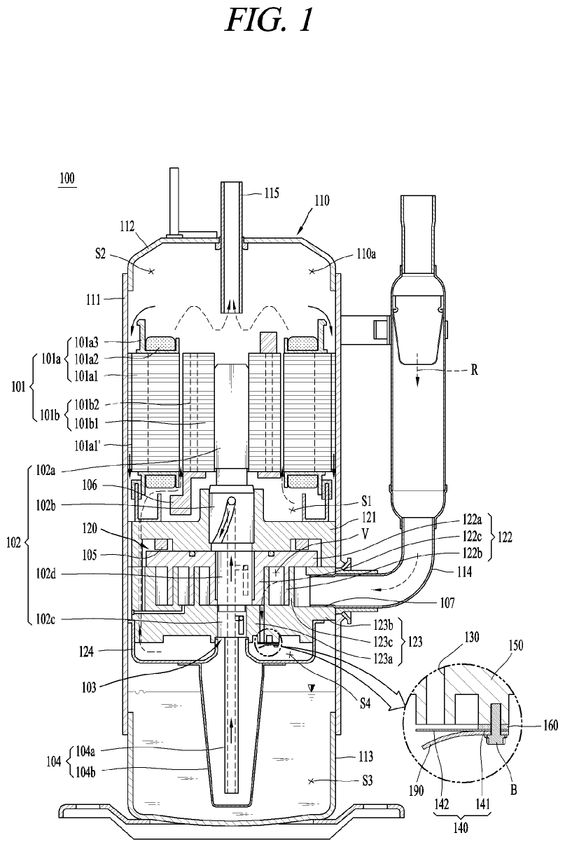

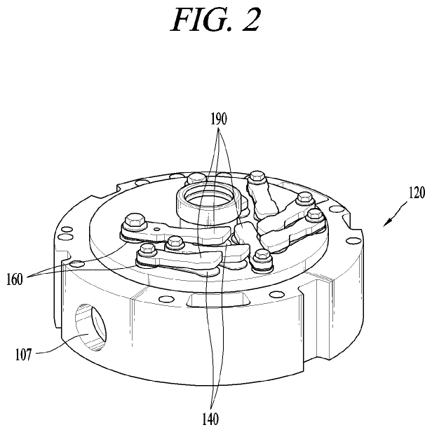

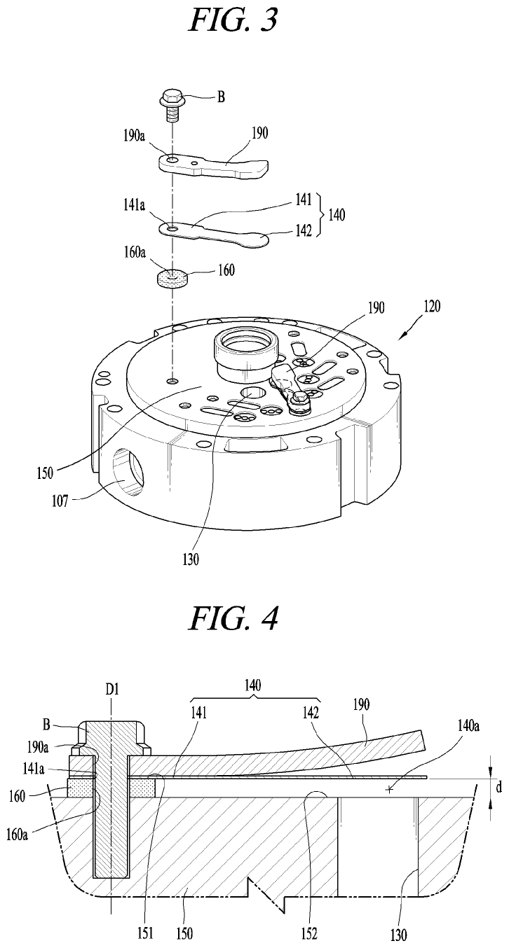

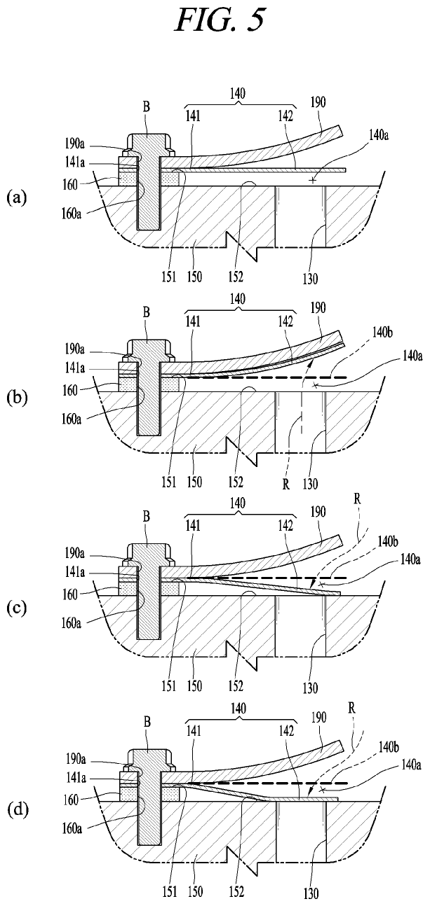

FIG. 1 is a cross-sectional view of a scroll compressor 100 in accordance with one embodiment of the present disclosure. FIG. 2 is a perspective view of a compression unit 120 illustrated in FIG. 1. FIG. 3 is an exploded perspective view illustrating components related to a partial valve member 140 in the compression unit 120 illustrated in FIG. 2. FIG. 4 is a view illustrating a cross-section of the compression unit 120 illustrated in FIG. 2 based on the valve member 140. FIG. 5 is a conceptual view illustrating a process of operating the valve member 140 illustrated in FIG. 4.

Referring to FIGS. 1 to 5, the scroll compressor 100 includes a casing 110, a compression unit (compression part) 120, a discharge port 130, a valve member 140, and a spacer 160.

The casing 110 define appearance of the scroll compressor 100. An inner space 110a of the casing 110 may be formed hermetically. The casing 110 may include a cylindrical shell 111, an upper shell 112, and a lower shell 113.

The cylindrical shell 111 may be formed in a cylindrical shape with both ends open. The upper shell 112 and the lower shell 133 may be coupled to the both ends of the cylindrical shell 111 to cover upper and lower openings of the cylindrical shell 111, respectively.

The inner space 110a of the casing 110 may be divided into a lower space S1 and an upper space S2 based on a drive motor 101 to be described later. An oil storage space S3 may be defined below the lower space S1 based on the compression unit 120. The lower space S1 may define a discharge space, and the upper space S2 may define an oil separation space.

A refrigerant suction pipe 115 may be formed in an L-shape, and one end portion of the refrigerant suction pipe 115 may be inserted through the cylindrical shell 111 to communicate with a suction port 107 of the compression unit 120.

A drive motor 101 may be disposed in an upper portion of the casing 110, and a main frame 121, an orbiting scroll 122, a fixed scroll 123, and a discharge cover 124 may be sequentially disposed below the drive motor 101. In general, the drive motor 101 may constitute a motor unit (motor part) of the scroll compressor 100, and the main frame 121, the orbiting scroll 122, the fixed scroll 123, and the discharge cover 124 may constitute the compression unit (compression part) 120.

The motor unit may be coupled to an upper end of a rotating shaft 102 to be described later, and the compression unit 120 may be coupled to a lower end of the rotating shaft 102. Accordingly, the scroll compressor 100 may have a bottom compression type structure in which refrigerant R is compressed in a lower portion of the scroll compressor 100. In addition, the compression unit 120 may be connected to the motor unit by the rotating shaft 102 so as to be operated by rotational force of the motor unit.

The drive motor 101 may include a stator 101a and a rotor 101b.

The stator 101a may be fitted onto an inner circumferential surface of the cylindrical shell 111. The rotor 101b may be rotatably disposed inside the stator 101a.

The stator 101a includes a stator core 101a1 and a stator coil 101a2.

The stator core 101a1 may be formed in a cylindrical shape, and may be shrink-fitted to the inner circumferential surface of the cylindrical shell 111. A plurality of recessed surfaces 101a1′ that are recessed in a D-cut shape along a lengthwise (longitudinal) direction may be formed on an outer circumferential surface of the stator core 101a1 at preset intervals along a circumferential direction.

A first oil return passage (not illustrated) through which oil passes may be defined between the recessed surfaces 101a1′ and the inner circumferential surface of the cylindrical shell 111. Accordingly, oil separated from refrigerant in the upper space S2 may move to the lower space S1 through the first oil return passage, and then return into the oil storage space S3 through a second oil return passage (not illustrated).

The stator coil 101a2 may be wound around the stator core 101a1 and may be electrically connected to an external power source through a terminal (not illustrated) that is coupled through the casing 110. An insulator 101a3 as an insulating member may be inserted between the stator core 101a1 and the stator coil 101a2.

The insulator 101a3 may extend long to both sides in the lengthwise direction to accommodate the stator coil 101a2 in a radial direction. A portion of the insulator 101a3 which extends downward may configure an oil separation portion (not illustrated) to prevent refrigerant discharged into the lower space S1 from being mixed with oil returned from the upper space S2.

The rotor 101b includes a rotor core 101b1 and permanent magnets 101b2.

The rotor core 101b1 may be formed in a cylindrical shape. The rotor core 101b may be rotatably inserted into the stator core 101a1 with a preset gap therebetween. The permanent magnets 101b2 are embedded in the rotor core 101b1 at preset intervals along a circumferential direction.

In addition, a balance weight 106 may be coupled to a lower end portion of the rotor core 101b1. Alternatively, the balance weight 106 may be coupled to a shaft portion 102a of the rotating shaft 102 to be described later.

The rotating shaft 102 may be coupled to the center of the rotor 101b. An upper end portion of the rotating shaft 102 is press-fitted to the rotor 101b. A lower end portion of the rotating shaft 102 may be rotatably inserted into the main frame 121 to be supported in the radial direction. An Oldham ring 105 may be rotatably inserted between the main frame 121 and the orbiting scroll 122 to be described later.

The rotating shaft 102 transfers rotational force of the drive motor 101 to the orbiting scroll 122 of the compression unit 120. Then, the orbiting scroll 122 which is eccentrically coupled to the rotating shaft 102 performs an orbiting motion relative to the fixed scroll 123.

The rotating shaft 102 includes a shaft portion 102a, a first bearing portion 102b, a second bearing portion 102c, and an eccentric portion 102d. An oil supply passage 103 for supplying oil to bearing-related components and the eccentric portion 102d of the scroll compressor 100 is defined in the rotating shaft 102.

In addition, an oil feeder 104 for pumping oil filled in the oil storage space S3 may be disposed on a lower end of the rotating shaft 102. The oil feeder 104 may include an oil suction pipe 104a connected in communication with the oil supply passage 103 of the rotating shaft 102, and a blocking member 104b for receiving the oil suction pipe 104a to block an intrusion of foreign substances to the oil suction pipe 104a. The oil suction pipe 104a may extend downward through the discharge cover 124 to be immersed in oil filled in the oil storage space S3.

The shaft portion 102a defines an upper portion of the rotating shaft 102. The shaft portion 102a is formed in a circular bar shape. The rotor 101b may be press-fitted to an upper portion of the shaft portion 102a.

The first bearing portion 102b is disposed on a lower portion of the shaft portion 102a, to support the shaft portion 102a in the radial direction of the shaft portion 102a.

The second bearing portion 102c is disposed on a lower end of the shaft portion 102a. The second bearing portion 102c supports the shaft portion 102a together with the first bearing portion 102b in the radial direction. The second bearing portion 102c may be formed coaxially with the first bearing portion 102b.

The eccentric portion 102d may be disposed between a lower end portion of the first bearing portion 102b and an upper end portion of the second bearing portion 102c. The eccentric portion 102d may be configured such that a center of rotation is radially eccentric with respect to the first bearing portion 102b or the second bearing portion 102c. Accordingly, the orbiting scroll 122 may perform an orbiting motion relative to the fixed scroll 121 when the rotating shaft 102 rotates.

The compression unit 120 may include the main frame 121, the orbiting scroll 122, the fixed scroll 123, and the discharge cover 124.

The main frame 121 is disposed beneath the drive motor 101 to accommodate the orbiting scroll 122 to be explained later.

The orbiting scroll 122 includes an orbiting end plate portion 122a, an orbiting wrap 122b, and a rotating shaft coupling portion 122c.

The orbiting end plate portion 122a may have a disk shape.

The orbiting wrap 122b may extend from a lower surface of the orbiting end plate portion 122a toward the fixed scroll 123. The orbiting wrap 122b is engaged with a fixed wrap 123c to form a compression chamber V.

The orbiting wrap 122b may be formed in an involute shape together with the fixed wrap 123c. However, the orbiting wrap 122b and the fixed wrap 123c to be described later may be formed in a shape other than the involute shape.

An inner end portion of the orbiting wrap 122b may be formed on a central portion of the orbiting end plate portion 122a, and the rotating shaft coupling portion 122c may be formed through the central portion of the orbiting end plate portion 122a in the axial direction.

The eccentric portion 102d of the rotating shaft 102 is rotatably inserted into the rotating shaft coupling portion 153. Accordingly, an outer circumferential portion of the rotating shaft coupling portion 122c is connected to the orbiting wrap 122b and serves to form the compression chamber V together with the fixed wrap 123c to be described later during a process of compressing refrigerant R.

The rotating shaft coupling portion 122c may be formed to have a height at which the rotating shaft coupling portion 122c overlaps the orbiting wrap 122b on the same plane. That is, the rotating shaft coupling portion 153 may be disposed at a height at which the eccentric portion 1254 of the rotating shaft 102 overlaps the orbiting wrap 152 on the same plane. Accordingly, repulsive force and compressive force of refrigerant R may cancel each other while being applied to the same plane based on the orbiting end plate portion 122a, and thus inclination of the orbiting scroll 122 due to interaction between the compressive force and the repulsive force may be suppressed.

The fixed scroll 123 may include a fixed end plate portion 123a, a fixed side wall portion 123b, and a fixed wrap 123c.

The fixed end plate portion 123a may have a disk shape. A discharge port 130 defining a passage through which the refrigerant R is discharged from the compression chamber V to the outside of the compression chamber V may be disposed in the fixed end plate portion 123a. The refrigerant R compressed in the compression chamber V may be discharged, through the discharge port 130, into a discharge space S4 of the discharge cover 124 to be described later. The discharge port 130 may be provided in plurality.

The fixed side wall portion 123b may extend in an annular shape from an edge of an upper surface of the fixed end plate portion 123a in the axial direction.

The fixed wrap 123c may extend from an upper surface of the fixed end plate portion 123a toward the orbiting scroll 122. The fixed wrap 123c is engaged with the orbiting wrap 122b to form the compression chamber V.

When power is applied to the drive motor 101, rotational force is generated and the rotor 101b and the rotating shaft 102 rotate accordingly. As the rotor 101b and the rotating shaft 102 rotate, the orbiting scroll 122 eccentrically coupled to the rotating shaft 102 performs an orbiting motion relative to the fixed scroll 123 by the Oldham ring 105. Accordingly, the refrigerant R is compressed in the compression chamber V.

The discharge cover 124 is disposed below the fixed scroll 123 to enclose the fixed scroll 123, thereby defining the discharge space S4 together with one surface of the fixed scroll 123.

Hereinafter, the valve member 140 will be described.

The valve member 140 opens and closes the discharge port 130 of the refrigerant R, which is disposed in the compression unit 120. Specifically, the refrigerant R flowing into the compression chamber V through the suction port 107 of the compression unit 120 is compressed and converted into a high-pressure state from a low-pressure state while the orbiting scroll 122 perform the orbiting motion related to the fixed scroll 123 by the operation of the drive motor 101. The compressed refrigerant R is discharged into the inner space 110a of the casing 110 through the discharge port 130. For example, the refrigerant R compressed in the compression chamber V may be discharged into the discharge space S4.

The valve member 140 may be formed in a cantilever shape having a fixed end and a free end. A root part 141 may be disposed on one end portion of the valve member 140, and a head part 142 may be disposed on another end portion of the valve member 140.

The root part 141 may be disposed on one end portion of the valve member 140 and fixed to a valve seat part 150 of the compression unit 120. A valve member fastening hole 141a for fixing the valve member 140 to the valve seat part 150 of the compression unit 120 may be formed in the root part 141. The root part 141 of the valve member 140 may be fixed by coupling a fastening member B such as a bolt to the compression unit 120 through the valve member fastening hole 141a.

The head part 142 is disposed on another end portion of the valve member 140 and is not in a fixed state. Accordingly, the head part 142 is made to be freely deformable relative to the root part 141 when external force is applied to the valve member 140. The head part 142 may be located at a position adjacent to the discharge port 130.

According to this structure of the valve member 140, the head part 142 is configured to open or close the discharge port 130 of the compression unit 120 as a pressure reversal phenomenon continuously occurs between the compression chamber V and the inner space 110a of the casing 110.

Specifically, as illustrated in (a) of FIG. 5, in a state before the pressure difference occurs between the discharge port 130 connected to the compression chamber V and the inner space 110a of the casing 110, namely, in a stop state of the compression unit 120 before the scroll compressor 100 is operated, the head part 142 of the valve member 140 remains stationary because there is no external force applied.

Next, as illustrated in (b) of FIG. 5, when the refrigerant R is compressed in the compression chamber V of the compression unit 120 so that pressure in the compression chamber V becomes higher than pressure in the inner space 110a of the casing 110, the refrigerant R in a high-pressure state, compressed in the compression chamber V, pushes the head part 142 of the valve member 140 away from the discharge port 130 while being discharged out of the compression chamber V through the discharge port 130. At this time, the head part 142 of the valve member 140 passes a valve parallel line 140b where the head part 142 of the valve member 140 in an initial state illustrated in (a) of FIG. 5 is located.

Next, as illustrated in (c) of FIG. 5, as the compression process of the refrigerant R in the compression chamber V proceeds, when the pressure in the compression chamber V becomes relatively lower than the pressure of the inner space 110a of the casing 110, the refrigerant R filled in the inner space 110a of the casing 110 reversely flows into the compression chamber V through the discharge port 130. Due to the flow of the refrigerant R, the head part 142 is pressed toward the discharge port 130. Accordingly, a portion of the head part 142 is brought into contact with one surface of the valve seat part 150 over the valve parallel line 140b.

Finally, as illustrated in (d) of FIG. 5, as an area of a lower surface of the head part 142 that is brought into contact with the one surface of the valve seat part 150 increases, the discharge port 130 is completely closed. The valve member 140 is configured to open and close the discharge port 130 while repeating the processes.

The spacer 160 may be disposed between the root part 141 of the valve member 140 and the valve seat part 150 facing the same. The spacer 160 may be disposed between the valve seat part 150 and the root part 141 of the valve member 140, and a valve fixing surface 151 may have a predetermined thickness so as to protrude from the valve seat part 150 by a predetermined height. Accordingly, the root part 141 of the valve member 140 may implement a structure in which the valve seat part 150 is spaced apart from one surface of the root part 141. Consequently, the head part 142 of the valve member 140 may be spaced, by a thickness of the spacer 160, apart from a valve opening and closing surface 152 where the discharge port 130 is formed. Meanwhile, a spacer fastening hole 160a may be formed through the spacer 160 such that the spacer 160 is fixedly coupled to the compression unit 120 by using a fastening member B such as a bolt.

Due to the configuration of the spacer 160, a spacing part 140a may be defined between the head part 142 of the valve member 140 and the valve seat portion part 150 facing the head part 142. Accordingly, the head part 142 of the valve member 140 may be spaced apart from the valve seat part 150 in the state in which the compression unit 120 is stopped. That is, the head part 142 of the valve member 140 is spaced a predetermined gap d apart from the discharge port 130 disposed in the compression unit 120, in a state before an occurrence of a pressure difference between the compression chamber V and the inner space 110a of the casing 110.

A height d of the spacing part 140a may be larger than or equal to the thickness of the valve member 140. That is, the spacing part 140a of the present disclosure is not made due to errors occurring during machining of the valve seat part 150 or machining or assembling of the valve member 140, but is made by a structural characteristic of the spacing part 140a and the valve member 140 or a structural characteristic related to an arrangement of the valve member 140 and the valve seat part 150.

The spacing part 140a may allow the head part 142 of the valve member 140 and the valve seat part 150 to secure a distance therebetween more stably, thereby providing a more stable effect of reducing impact noise generated during the operation of the valve member.

According to this structure of the head part 142 of the valve member 140, as the compression unit 120 operates and the valve member 140 is closed, the head part 1420 may be configured to move over the valve parallel line 140b and then collide with one surface of the valve seat part 150. That is, a distance until the head part 142 of the valve member 140 collides with the one surface of the valve seat part 150 may be increased. This can cause resistance against the movement of the head part 142 by rigidity of the valve member 140 for a predetermined period of time until before the head part 142 collides with the one surface of the compression unit 120.

Consequently, in the scroll compressor 100 according to the present disclosure, when the valve member 140 opens and closes the discharge port 130, a speed at which the head part 142 of the valve member 140 moves may be reduced, so as to reduce impact force, by which the head part 142 of the valve member 140 collides with the one surface of the compression unit 120, and thus decrease impact noise generated due to the collision.

Meanwhile, the scroll compressor 100 may further include a retainer 190.

The retainer 190 is disposed on an opposite side of the compression unit 120 with the valve member 140 interposed therebetween. One end portion of the retainer 190 is fixed to the compression unit 120 together with the root part 141 of the valve member 140, and another end portion of the retainer 190 is bent in a direction away from the compression unit 120. The retainer 190 is configured to limit the degree of bending of the head part 142 of the valve member 140 when the valve member 140 opens and closes the discharge port 130. In addition, the valve member 140 and the retainer 190 may be made of different materials such as steel and cast iron. A retainer fastening hole 190a for fixing the retainer 190 to the compression unit 120 may be formed through the one end portion of the retainer 190.

For reference, in the case of a typical scroll compressor, even when there is no separate valve structure for opening and closing the discharge port 130, the compression of refrigerant R is carried out in stages in the compression chamber V. However, the reason why the valve structure is provided for opening and closing the discharge port 130 in the scroll compressor is to suppress high pressure refrigerant R discharged from the compression chamber V through the discharge port 130 flows back into the compression chamber V which changes to a relatively low-pressure state.

Meanwhile, the valve seat part 150 may include a valve fixing surface 151 and a valve opening and closing surface 152. The valve seat part 150 is formed on one surface of the compression unit 120 facing the valve member 140. The valve seat part 150 may be formed around the discharge port 130. The valve fixing surface 151 defines an area where the root part 141 of the valve member 140 is fixed. Also, the valve opening and closing surface 152 defines an area where the head part 142 of the valve member 140 is open and closed.

Here, the valve fixing surface 151 may be formed at a higher position than the valve opening and closing surface 152.

According to the structure of the root part 141 of the valve member 140, a lower surface of the head part 142 may be spaced apart from one surface of the valve seat part 150 by an increased height of a lower surface of the root part 141 from the one surface of the valve seat part 150 facing the valve member 140. This can increase a distance until the head part 142 of the valve member 140 collides with one surface of the compression unit 120 provided with the discharge port 130. As a result, when the valve member 140 is closed, a speed at which the head part 142 of the valve member 140 moves may be reduced due to the rigidity of the valve member 140. This can reduce impact noise that is generated when the head part 142 of the valve member 140 collides with the one surface of the compression unit 120.

Meanwhile, the spacer 160 may be inserted between the valve member 140 and the valve seat part 150. Through this, as illustrated in FIGS. 2 and 3, the structure of the spacing part 140a can be easily implemented through a process of assembling or bonding the valve member 140 and the spacer 160.

In addition, the spacer 160 may be formed in an annular shape and have the same outer diameter along an axial direction Dl. According to the structure of the spacer 160 as described above, while more simplifying the structure of the spacer 160, the impact noise due to the valve member 140 can be reduced by the structure of the spacing part 140a defined between the head part 142 of the valve member 140 and the valve seat part 150 facing the head part 142.

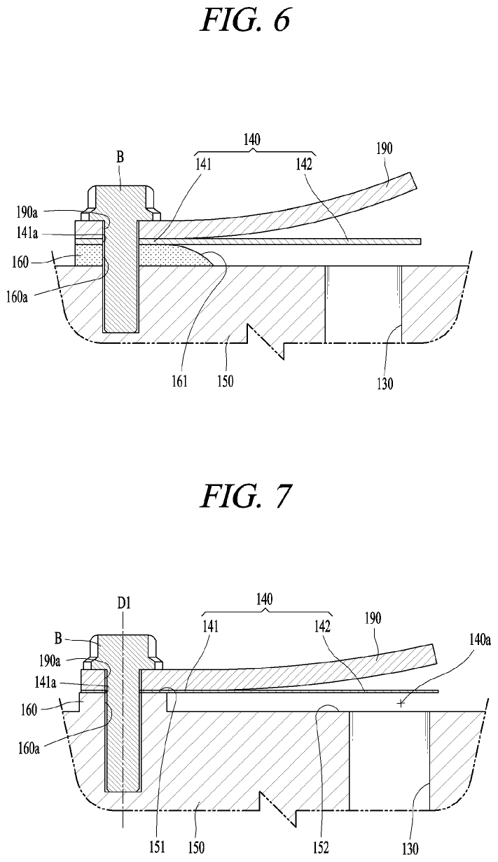

Hereinafter, different examples of the scroll compressor 100 will be described with reference to FIGS. 6 to 12 together with FIGS. 1 to 5.

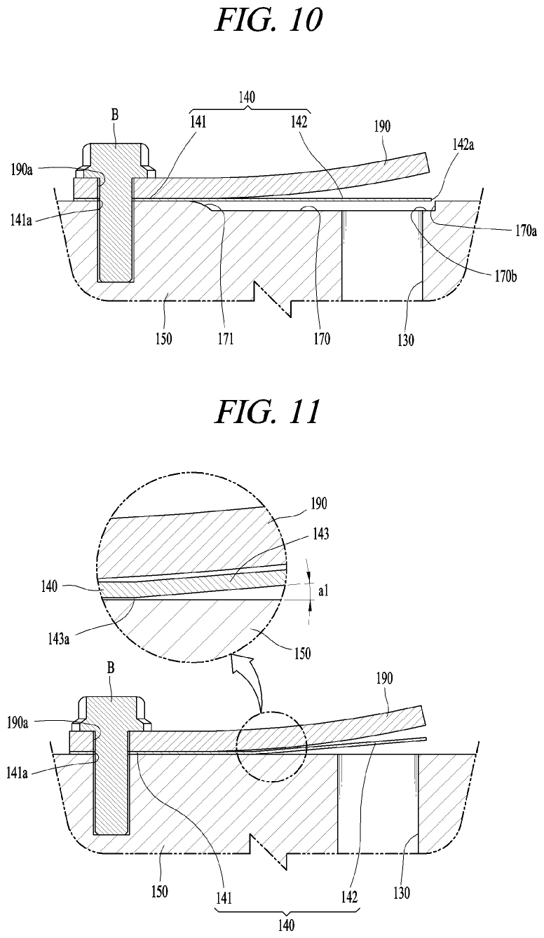

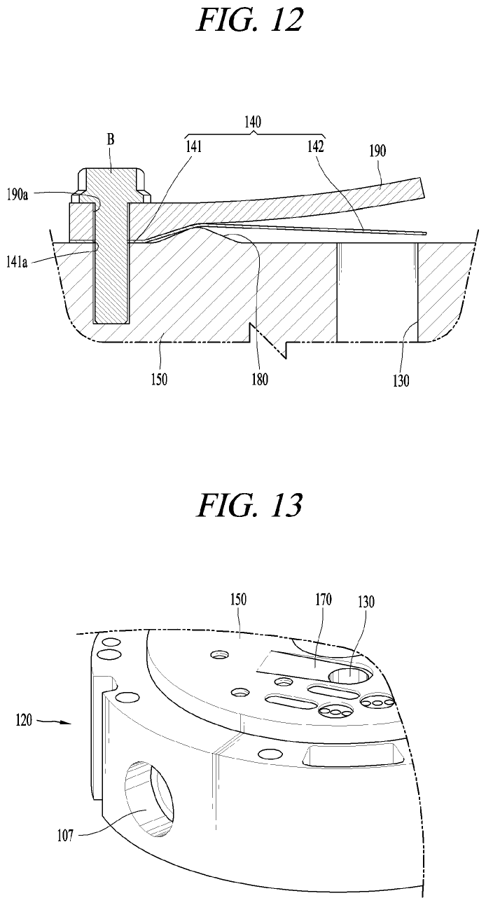

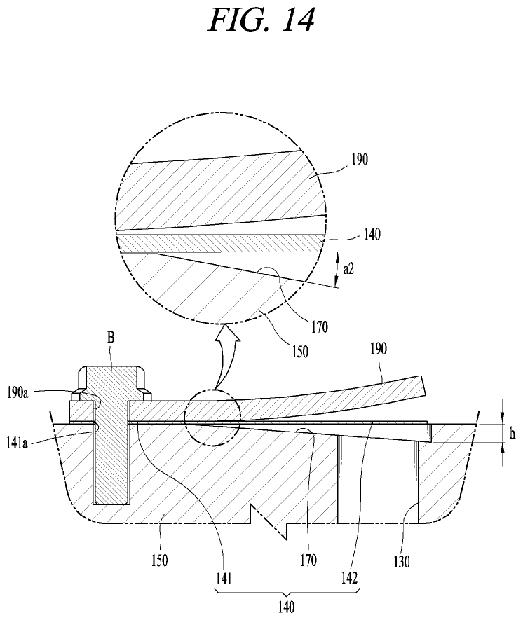

FIGS. 6 to 8 are cross-sectional views illustrating different examples of the scroll compressor 100 illustrated in FIG. 1 based on the valve member. FIG. 9 is a perspective view illustrating a compression unit 120 according to still another example of the scroll compressor 100 illustrated in FIG. 1. FIG. 10 is a schematic view illustrating a cross-section of the compression unit 120 illustrated in FIG. 9. FIGS. 11 to 12 are cross-sectional views illustrating different examples of the scroll compressor 100 illustrated in FIG. 1 based on the valve member 140. FIG. 13 is a perspective view illustrating a compression unit 120 according to still another example of the scroll compressor 100 illustrated in FIG. 1. FIG. 14 is a schematic view illustrating a cross-section of the compression unit 120 illustrated in FIG. 13.

First, referring to FIG. 6, the spacer 160 may include a chamfered portion 161.

The chamfered portion 161 is disposed on one end portion facing the discharge port 130, and may be inclined downward in the direction toward the discharge port 130. In FIG. 6, the chamfered portion 161 is shown having a curved shape that protrudes outward, but the shape of the chamfered portion 161 is not limited thereto, and may alternatively be formed to have a linear inclination or an embossed inclination that is toothed or concave and convex. According to the structure of the chamfered portion 161 as described above, when the valve member 140 opens and closes the discharge port 130, an area in contact with one surface of the spacer 160 on the lower surface of the valve member 140 may gradually increase. As a result, stress concentration that occurs at a portion adjacent to the root part 141 of the valve member 140 can be minimized, thereby improving durability of the valve member 140.

On the other hand, the spacer 160 may be disposed on the root part 141 of the valve member 140 or the valve seat part 150 facing the root part 141, and may protrude from the valve member 140 toward the valve seat part 140 or from the valve seat part 150 toward the root part 141 by a predetermined height.

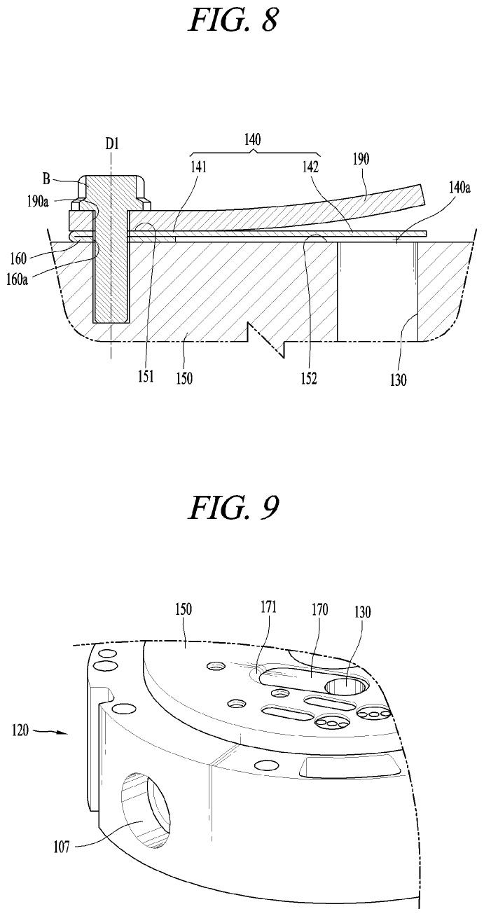

For example, as illustrated in FIG. 7, the spacer 160 may extend from the valve seat part 150 toward the root part 141 to protrude by the predetermined height. In addition, the spacer 160 may be disposed on the root part 141 of the valve member 140 and protrude from the root part 141 of the valve member 140 toward the valve seat part 150. For example, as illustrated in FIG. 8, the spacer 160 may be formed by bending one end portion of the root part 141 extending from the head part 142 back toward the head part 142. According to the structure of the spacer 160, a separate component that is supposed to be assembled to implement the spacing part 140a can be excluded, thereby more simplifying those components of the scroll compressor 100 related to the valve member 140.

Meanwhile, a recess portion 170 may be formed in the valve opening and closing surface 152 of the valve seat part 150.

As illustrated in FIGS. 9 and 10, the recess portion 170 may be recessed, by a predetermined depth, into one surface of the valve seat part 140 facing the valve member 140 such that the head part 142 of the valve member 140 is spaced apart from the discharge port 130.

According to the structure of the recess portion 170, the head part 142 can be spaced apart from the one surface of the valve seat part 150, which may result in excluding a separate configuration for reducing impact noise generated during operation of the valve member 140. This can more simplify the components for opening and closing the discharge port 130 disposed in the compression unit 120. By virtue of the exclusion of the separate component that is supposed to be assembled, reliability of the operation of the valve member 140 can be secured even when the valve member 140 is frequently open and closed.

In addition, based on the root part 141 of the valve member 140, a distance up to an end 170a of the recess portion 170 may be longer than a distance up to an end 142a of the head part 142. That is, when the valve member 140 opens and closes the discharge port 130, the end 142a of the head part 142 may be closer to the root part 141 than the end 170a of the recess portion 170, such that the head part 142 of the valve member 140 is all received in the recess portion 170. The structure of the head part 142 and the recess portion 170 can minimize a possibility that the head part 142 unnecessarily collides with any portion of the valve seat part 150 on a movement path of the valve member 140. Accordingly, an area in which a collision of the valve member 140 may occur can be decreased, and thus impact noise generated when the valve member 140 opens and closes the discharge port 130 can be more reduced.

The recess portion 170 corresponding to the head part 142 of the valve member 140 may be provided with a valve seat surface 170b that is formed along a periphery of the discharge port 130 to be larger than an outer diameter of the head part 142, such that the head part 142 is seated therein. That is, one end portion of the recess portion 170 corresponding to the head part 142 of the valve member 140 may be formed up to a position far from a center of the discharge port by a distance longer a radius of the discharge port. Accordingly, when the valve member 140 opens and closes the discharge port 130, an area where the head part 142 of the valve member 140 is seated on the periphery of the discharge port 130 can be stably secured. As a result, reliability of the function of the valve member 140 for closing the discharge port 130 can be further improved.

The recess portion 170 may be provided with an inclined portion 171.

Specifically, as illustrated in FIGS. 9 and 10, the recess portion 170 is formed in a long groove shape in a longitudinal direction of the valve member 140, and the discharge port 130 may be formed eccentrically on a side far from the root part 141 of the valve member 140. Here, the inclined portion 171 may be formed to be inclined downward on a portion of an inner circumferential surface of the recess portion 170 which is adjacent to the root part 141.

In FIGS. 9 and 10, the inclined portion 171 is shown having a curved shape that protrudes outward, but the shape of the inclined portion 171 is not limited thereto, and may alternatively be formed, when a cross-section of the inclined portion 171 is considered as illustrated in FIG. 10, to have a linear inclination or an embossed inclination that is toothed or concave and convex.

According to the structure of the inclined portion 171 as described above, an area where a portion of the lower surface of the valve member 140 adjacent to the root part 141 comes into contact with one surface of the recess portion 170 may gradually increase. This can minimize stress concentration that occurs on a portion adjacent to the root part during the opening and closing operation of the valve member 140.

Also, as illustrated in FIGS. 11 and 12, the recess portion 170 may be formed such that a recessed depth h increases in a direction toward the discharge port 130. In other words, the recess portion 170 may be formed such that the recessed depth h decreases from one end portion thereof corresponding to the head part 142 of the valve member 140 toward another end portion. That is, the recess portion 170 may be formed such that the recessed depth h gradually increases from the root part 141 of the valve member 140 to the head part 142. According to the structure of the recess portion 170 as described above, one surface of the recess portion 170 50 may be inclined at a predetermined angle a2 with respect to the lower surface of the valve member 140. Accordingly, when the valve member 140 opens and closes the discharge port 130, an area where the lower surface of the valve member 140 and the one surface of the recess portion 170 come into contact with each other may gradually increase. This can minimize the phenomenon that the stress concentration occurs on the portion adjacent to the root member 141 of the valve member 140 during the opening and closing operation of the valve member 140.

On the other hand, when viewed from a side, the root part 141 and the head part 142 of the valve member 140 may extend linearly along the valve seat part 150 to be formed in a flat plate shape. This can minimize impact noise generated during the operation of the valve member 140 and facilitate the valve member 140 in the flat plate shape with excellent machining and assembly properties to be applied to the scroll compressor 100.

Meanwhile, the valve member 140 may be provided with an elastic part 143 interposed between the root part 141 and the head part 142. The elastic part 143 may be provided with a bent portion 143a.

The elastic part 143 may be elastically deformable. As illustrated in FIG. 11, the bent portion 143a is formed between the root part 141 and the head part 142 of the valve member 140, and is bent at a predetermined angle a1 such that the head part 142 is directed away from the discharge port 130. By virtue of the structure of the bent portion 143a, a separate configuration by which the head part 142 of the valve member 140 is spaced apart from the one surface of the valve seat part 150 facing the valve member 140 can be excluded. Instead, the head part 142 can be spaced apart from the one surface of the valve seat part 150 by using the structural characteristic of the bent portion 143a. Accordingly, the components for opening and closing the discharge port 130 disposed in the compression unit 120 can be more simplified.

In addition, the bent portion 143a may be formed in at least one of an angular shape and a curved shape. Accordingly, when designing the scroll compressor 100, the degree to which the head part 142 of the valve member 140 is spaced apart from the one surface of the valve seat part 150 and a time during which the head part 132 of the valve member 140 opens and closes the discharge port 130 can be designed in more various ways.

Meanwhile, the scroll compressor 100 may further include a protrusion 180.

The protrusion 180 allows any portion of the valve member 140 between the root part 141 and the head part 142 to be spaced apart from the one surface of the valve seat part 150. Here, the protrusion 180 may be formed at a position closer to the root part 141 than the head part 142. Also, as illustrated in FIG. 12, the protrusion 180 may protrude from the one surface of the valve seat part 150 by a predetermined height. The protrusion 180 may be machined to form an integral body with the valve seat part 150.

According to the structure of the protrusion 180, the head part 142 of the valve member 140 can be spaced apart from the one surface of the valve seat part 150, which may result in excluding a separate configuration for reducing impact noise generated during the operation of the valve member 140. This can exclude a portion for assembling or bonding a separate component related to the operation of the reed-type valve member 140. As a result, even when the valve member 140 frequently opens and closes the discharge port 130, reliability of the operation of the valve member 140 can be more secured.

The foregoing description is merely illustrative, and various modifications may be made by those skilled in the art to which the present disclosure belongs without departing from the scope and technical idea of the described embodiments. The foregoing embodiments may be implemented individually or in any combination.

1. A scroll compressor comprising:
a casing;
a compression unit disposed in an inner space of the casing, having a compression chamber to compress suctioned refrigerant therein, and discharging the refrigerant compressed in the compression chamber into the inner space of the casing;
a discharge port defining a flow path through which the refrigerant compressed in the compression chamber is discharged to outside of the compression chamber; and
a valve member having a root part disposed on one end portion thereof to be fixed to a valve seat part of the compression unit, and a head part disposed on another end portion to define a free end so as to open and close the discharge port,
wherein a spacing part is disposed between the head part of the valve member and the valve seat part facing the head part such that the head part is spaced apart from the valve seat part in a stopped state of the compression unit.

2. The scroll compressor of claim 1, wherein the valve seat part includes a valve fixing surface to which the root part of the valve member is fixed, and a valve opening and closing surface to open and close the head part of the valve member, and
the valve fixing surface is located at a position higher than the valve opening and closing surface.

3. The scroll compressor of claim 2, wherein a spacer is disposed between the root part of the valve member and the valve seat part facing the root part such that the valve fixing surface protrudes from the valve seat part by a predetermined height.

4. The scroll compressor of claim 3, wherein the spacer is inserted between the valve member and the valve seat part.

5. The scroll compressor of claim 3, wherein the spacer is disposed on the root part of the valve member or the valve seat part facing the root part, and protrudes from the valve member toward the valve seat part or protrudes from the valve seat part to the root part by a predetermined height.

6. The scroll compressor of claim 3, wherein the spacer is formed in an annular shape and has the same outer diameter along an axial direction.

7. The scroll compressor of claim 3, wherein the spacer includes a chamfer portion inclined downward in a direction toward the discharge port.

8. The scroll compressor of claim 1, wherein the valve seat part comprises a valve opening and closing surface that encloses a periphery of the discharge port and is detachable from the head part, and
the valve opening and closing surface comprises a recess portion recessed by a predetermined depth such that the head part and the discharge port are spaced apart from each other.

9. The scroll compressor of claim 8, wherein a distance from the root part to an end of the recess portion is longer than a distance from the root part to an end of the head part.

10. The scroll compressor of claim 8, wherein the recess portion corresponding to the head part comprises a valve seat surface formed to be larger than an outer diameter of the head part along the periphery of the discharge port to receive the head part.

11. The scroll compressor of claim 8, wherein the recess portion is formed such that a recessed depth increases in a direction toward the discharge port.

12. The scroll compressor of claim 8, wherein the recess portion is formed in a long groove shape along a longitudinal direction of the valve member,
the discharge port is formed eccentrically on a side far from the root part, and
an inclined portion is formed to be inclined downward on a portion, adjacent to the root part, of an inner circumferential surface of the recess portion.

13. The scroll compressor of claim 1, wherein the valve member is formed in a flat plate shape, when viewed from a side, by extending the root part and the head part linearly along the valve seat part.

14. The scroll compressor of claim 1, wherein the valve member comprises an elastic part disposed between the root part and the head part, and
the elastic part comprises a bent portion bent such that the head part is directed away from the valve seat part.

15. The scroll compressor of claim 1, further comprising a protrusion protruding from the valve seat part toward the valve member,
wherein the protrusion is located at a position closer to the root part than to the head part.

16. The scroll compressor of claim 1, wherein a height of the spacing part is larger than or equal to a thickness of the valve member.
